(19) United States
(12) Patent Application Publication
(10) Pub. No.: US 2021/0276477 A1
(43) Pub. Date: Sep. 9, 2021

(54) CONTROL APPARATUS, VEHICLE, NON-TRANSITORY COMPUTER READABLE MEDIUM, AND CONTROL METHOD

(71) Applicant: TOYOTA JIDOSHA KABUSHIKI KAISHA, Toyota-shi (JP)

(72) Inventors: Hiromitsu FUJII, Kariya-shi (JP); Kohei MIWA, Nisshin-shi (JP); Yuko MIZUNO, Nagoya-shi (JP); Shinsuke ARIGA, Nagoya-shi (JP); Hirotaka OMISHA, Nisshin-shi (JP); Tsuyoshi OKADA, Nagoya-shi (JP)

(73) Assignee: TOYOTA JIDOSHA KABUSHIKI KAISHA, Toyota-shi (JP)

(21) Appl. No.: 17/190,657

(22) Filed: Mar. 3, 2021

(30) Foreign Application Priority Data
Mar. 3, 2020 (JP) 2020-036230

(51) Int. Cl. B60P 3/025; G06Q 30/06; G06Q 30/02; G08G 1/00

(52) U.S. Cl. CPC B60P 3/0257; G06Q 30/0645; G06Q 30/0283; G01C 21/343; G06Q 30/0623; G06Q 30/0281; G08G 1/202

(57) ABSTRACT

A control apparatus for controlling a vehicle, the control apparatus including a controller that is configured to: identify a vehicle that stores a product in accordance with attribute information for a user, or a vehicle that can provide a service in accordance with the attribute information; and perform control to move the vehicle to provide the product or the service at a location of the user.

### CROSS-REFERENCE TO RELATED APPLICATION

This application claims priority to Japanese Patent Application No. 2020-036230 (filed on Mar. 3, 2020), the entire contents of which are incorporated herein by reference.

### TECHNICAL FIELD

The present disclosure relates to a control apparatus, a vehicle, a program, and a control method.

### BACKGROUND

Navigation apparatuses that propose a travel plan, provide route guidance when the proposed travel plan is selected by a driver, and receive a satisfaction rating from a user after completion of the route guidance are known (for example, Patent Literature [PTL] 1).

### CITATION LIST

### Patent Literature

PTL 1: JP 2009-258026 A

### SUMMARY

The navigation apparatus described above proposes a travel plan for a traveler, but does not execute a process that considers reducing baggage to be brought by the user to a travel destination.

It would be helpful to provide a control apparatus, a vehicle, a program, and a control method, which enable a user to travel to a travel destination without bringing baggage.

A control apparatus according to an embodiment of the present disclosure is for controlling a vehicle. The control apparatus includes a controller, wherein the controller is configured to:

identify a vehicle that stores a product in accordance with attribute information for a user, or a vehicle that can provide a service in accordance with the attribute information; and

perform control to move the vehicle to provide the product or the service at a location of the user.

A program according to an embodiment of the present disclosure is configured to cause a computer, as a control apparatus for controlling a vehicle, to execute:

identifying a vehicle that stores a product in accordance with attribute information for a user, or a vehicle that can provide a service in accordance with the attribute information; and

control to move the vehicle to provide the product or the service at a location of the user.

A control method according to an embodiment of the present disclosure is performed by a control apparatus for controlling a vehicle. The control method includes:

identifying a vehicle that stores a product in accordance with attribute information for a user, or a vehicle that can provide a service in accordance with the attribute information; and

control to move the vehicle to provide the product or the service at a location of the user.

The control apparatus, the vehicle, the program, and the control method according to embodiments of the present disclosure enable a user to travel without bringing baggage to a travel destination.

### BRIEF DESCRIPTION OF THE DRAWINGS

In the accompanying drawings:

FIG. 1 is a schematic diagram of an information processing system;

FIG. 2 is a block diagram illustrating a configuration of a control apparatus;

FIG. 3 is a block diagram illustrating a configuration of a vehicle;

FIG. 4 is a block diagram illustrating a configuration of a user terminal;

FIG. 5 is a diagram illustrating a data structure of an attribute database (DB);

FIG. 6 is a diagram illustrating a data structure of a vehicle DB;

FIG. 7 is a diagram illustrating a data structure of a schedule DB;

FIG. 8 is a diagram illustrating provision of products;

FIG. 9 is a diagram illustrating provision of services; and

FIG. 10 is a flow chart illustrating operation of the control apparatus.

### DETAILED DESCRIPTION

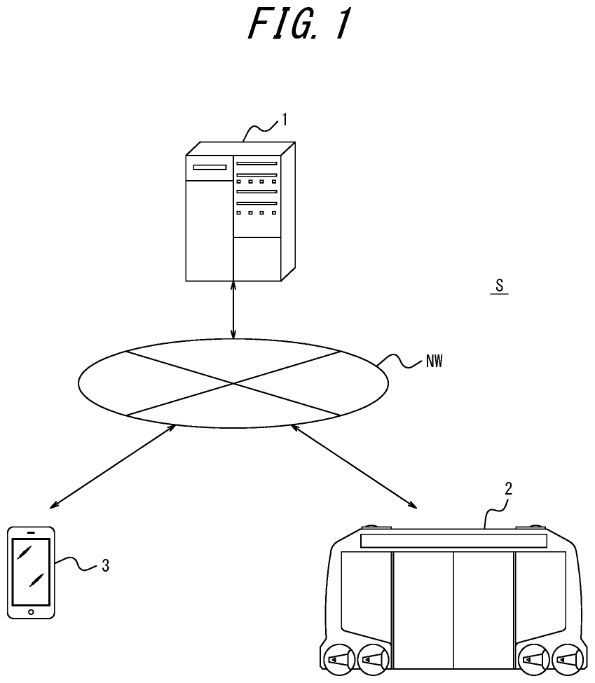

FIG. 1 is a schematic diagram of an information processing system S according to an embodiment. The information processing system S includes a control apparatus 1, a vehicle 2, and a user terminal 3, which are communicably connected to each other. FIG. 1 illustrates one of each of the control apparatus 1, the vehicle 2, and the user terminal 3, for convenience of explanation. However, the number of control apparatuses 1, the number of vehicles 2, and the number of user terminals 3 are not limited to one. The control apparatus 1, the vehicle 2, and the user terminal 3 are connected, for example, via a network NW which includes a mobile communication network and the Internet.

The control apparatus 1 may be a server that assists a provider in providing a vehicle dispatch service. The control apparatus 1 may be, for example, installed in a facility dedicated to a vehicle dispatch provider or in a shared facility including a data center. As an alternative example, the control apparatus 1 may be mounted in the vehicle 2.

The vehicle 2 is controlled by the control apparatus 1. The vehicle 2 includes, for example, any type of automobile such as a gasoline vehicle, a diesel vehicle, an HV, a PHV, an EV, or an FCV. The term “HV” is an abbreviation of Hybrid Vehicle. The term “PHV” is an abbreviation of Plug-in Hybrid Vehicle. The term “EV” is an abbreviation of Electric Vehicle. The term “FCV” is an abbreviation of Fuel Cell Vehicle. Although the driving of the vehicle 2 is automated at any level in the present embodiment, the vehicle 2 may be driven by a driver in another embodiment. The automation level is, for example, any one of Level 1 to Level 5 according to the level classifications defined by the SAE. The name “SAE” is an abbreviation of Society of Automotive Engineers. The vehicle 2 may be a MaaS-dedicated vehicle. The term “MaaS” is an abbreviation of Mobility as a Service.

The user terminal 3 is a terminal possessed by a user. The user terminal 3 may be, for example, a mobile device including a mobile phone, a smartphone, or a tablet, or may be a PC. The term “PC” is an abbreviation of Personal Computer.

An outline of processing that is executed by the control apparatus 1 according to the present embodiment will be described. The control apparatus 1 controls the vehicle 2. The control apparatus 1 identifies the vehicle that stores a product according to attribute information for the user, or the vehicle that can provide a service according to the attribute information. The control apparatus 1 controls the vehicle 2 to move to provide the product or the service at a location of the user. The above configuration allows the control apparatus 1 to provide the user who is on a trip with the product or the service according to the attribute information for the user. Therefore, the user can reduce an amount of baggage to bring to the travel destination. Thus, the control apparatus 1 enables the user to travel freely, without taking baggage.

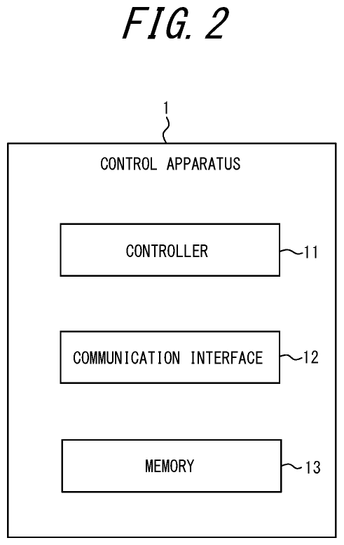

With reference to FIG. 2, an internal configuration of the control apparatus 1 will be described in detail.

The control apparatus 1 includes a controller 11, a communication interface 12, and a memory 13. The components of the control apparatus 1 are communicably connected to one another via, for example, a dedicated line.

The controller 11 includes, for example, one or more general-purpose processors including a Central Processing Unit (CPU) or a Micro Processing Unit (MPU). The controller 11 may include one or more dedicated processors that are dedicated to specific processing. The controller 11 may include one or more dedicated circuits instead of the processor. Examples of dedicated circuits may include a Field-Programmable Gate Array (FPGA) and an Application Specific Integrated Circuit (ASIC).

The communication interface 12 includes, for connecting to the network NW, one or more communication modules that conform to wired or wireless Local Area Network (LAN) standards. The communication interface 12 may include one or more modules conforming to mobile communication standards including the 4th Generation (4G) standard or the 5th Generation (5G) standard. The communication interface 12 may include one or more communication modules conforming to near field communication standards or specifications, including Bluetooth (Bluetooth is a registered trademark in Japan, other countries, or both), AirDrop (AirDrop is a registered trademark in Japan, other countries, or both), IrDA, ZigBee (ZigBee is a registered trademark in Japan, other countries, or both), Felica (Felica is a registered trademark in Japan, other countries, or both), or RFID. The communication interface 12 is configured to transmit and receive any information via the network NW. The optional information includes, for example, positional information acquired through the Global Positioning System (GPS).

The memory 13 may be, but is not limited to, a semiconductor memory, a magnetic memory, or an optical memory. The memory 13 may function as, for example, a main memory, an auxiliary memory, or a cache memory. The memory 13 may store information resulting from analysis or processing performed by the controller 11. The memory 13 may store various types of information regarding operation and control of the control apparatus 1. The memory 13 may include a system program, an application program, embedded software, and the like. The memory 13 of the present embodiment includes an attribute information DB, a vehicle DB, and a schedule DB. As an alternative example, the attribute information DB, the vehicle DB, and the schedule DB may be stored in a storage device outside the control apparatus 1.

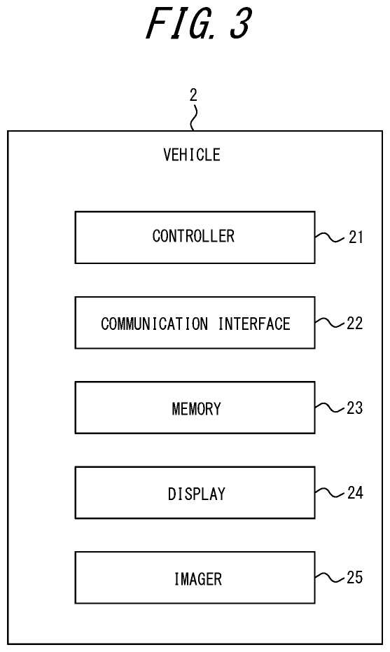

With reference to FIG. 3, an internal configuration of the vehicle 2 will be described in detail.

The vehicle 2 includes a controller 21, a communication interface 22, a memory 23, a display 24, and an imager 25. The components of the vehicle 2 are communicably connected to one another via, for example, a dedicated line. In the present embodiment, hardware components of the controller 21, the communication interface 22, and the memory 23 are the same as the hardware components of the controller 11, the communication interface 12, and the memory 13 of the control apparatus 1. Therefore, a description thereof is omitted here.

The display 24 is a display interface, and includes, for example, a panel display. The display 24 may display information read from the memory 23, an image captured by the imager 25, or information generated by the controller 21.

The imager 25 includes a camera and can capture an image of surroundings. The imager 25 may store the captured image in the memory 23 or transmit the captured image to the controller 21 for the purpose of analysis.

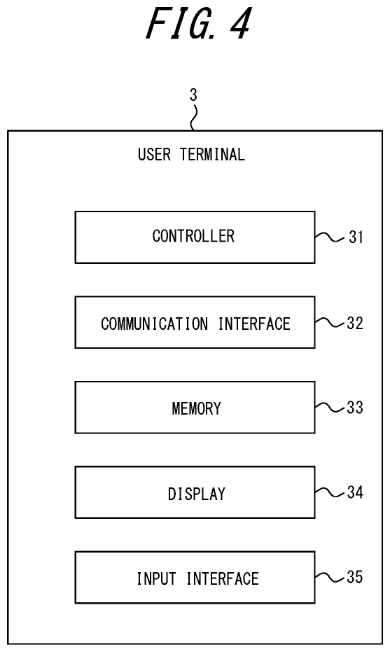

With reference to FIG. 4, an internal configuration of the user terminal 3 will be described in detail.

The user terminal 3 includes a controller 31, a communication interface 32, a memory 33, a display 34, and an input interface 35. The components of the user terminal 3 are communicably connected to one another, for example, via a dedicated line. In the present embodiment, the hardware components of the controller 31, the communication interface 32, the memory 33, and the display 34 are the same as the hardware components of the controller 21, the communication interface 22, the memory 23, and the display 24 of the vehicle 2. Therefore, a description thereof is omitted here.

The input interface 35 includes one or more input interfaces that detect a user input and send input information to the controller 31. Examples of input interfaces may include, but are not limited to, a physical key, a capacitive key, a touch screen integrally provided in the panel display, a microphone configured to receive audio input, and an IC card reader.

Hereinafter, processing executed in the information processing system S according to the present embodiment will be described in detail. Here, a scenario in which a user who uses the user terminal 3 departs for a sightseeing spot will be described as an example. A user ID of the user is U01.

The user operates the user terminal 3 to input attribute information. The attribute information includes information on a hobby or a preference, information on a travel destination, and information on an accompanying person. Additionally or alternatively, the attribute information may include other information.

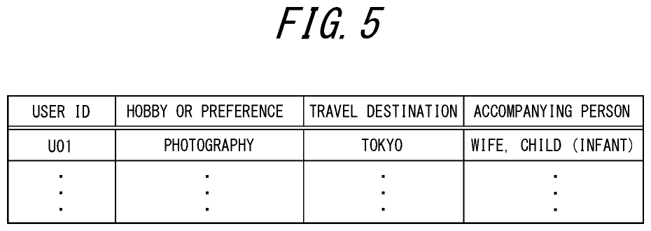

The user terminal 3 transmits the input attribute information to the control apparatus 1. As illustrated in FIG. 5, upon acquiring the attribute information, the control apparatus 1 stores, in an attribute information DB in the memory 13, the attribute information in association with the user U01.

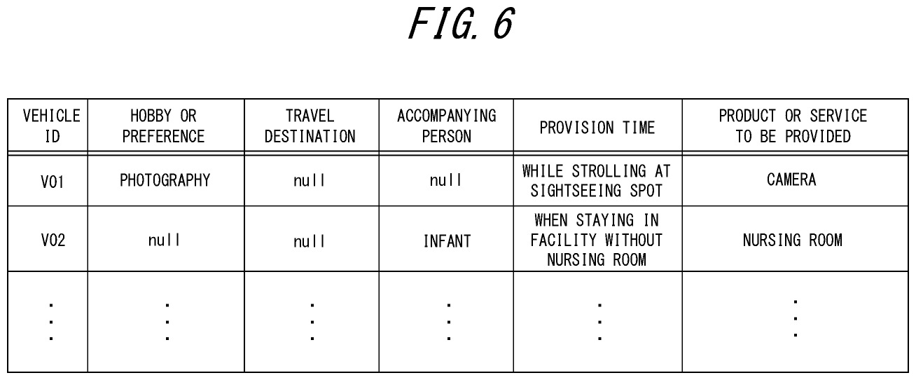

The memory 13 of the control apparatus 1 includes a vehicle DB. As illustrated in FIG. 6, the vehicle DB stores information on “hobby or preference”, “travel destination”, “accompanying person”, “provision time”, and “product or service to be provided”, in association with a vehicle ID.

A “camera”, which is stored as the “product or service to be provided”, is the product to be provided in vehicle V01. The type of camera may be freely selected and may be, for example, the latest single-lens reflex camera provided by a manufacturer. The product to be provided is not limited to this, and as an alternative example, a tripod, a telescope, a stroller, a climbing supply, or clothing may be provided. As another alternative example, a plurality of products may be provided in a single vehicle 2.

A “nursing room” is a service that is provided in vehicle V02. The service to be provided is not limited to this, and as an alternative example, a daycare center, a dresser, a coin laundry, an exchange counter, a cafe, a souvenir shop, or a photography studio may be provided. In a case in which the photography studio is provided, a photograph is taken by an imager 25 provided in the vehicle 2 or by an unmanned aerial vehicle (for example, a drone) that is communicatively connected to the vehicle 2. The photograph taken may be edited, at the photography studio, in the form of, for example, a movie or an album, and may be stored in a medium to be mailed to a home of the user, which is registered in advance. As an alternative example, the photograph taken may be transmitted to the user terminal 3.

The control apparatus 1 identifies the vehicle 2 that stores the product according to the attribute information, or the vehicle 2 that can provide the service according to the attribute information. Specifically, the control apparatus 1 searches the vehicle DB for a record which matches at least one of the input attribute information. In the examples illustrated in FIG. 5 and FIG. 6, the information on “photography”, which is input as the information on “hobby or preference” of user U01, matches the information on “photography” that is stored in association with vehicle V01 in FIG. 6. The control apparatus 1 identifies vehicle V01 as the vehicle 2 to be dispatched.

In the examples shown in FIG. 5 and FIG. 6, the information on “child (infant)” input as the information on “accompanying person” of the user U01 matches the information on “infant” that is stored in association with vehicle V02 in FIG. 6. The control apparatus 1 identifies vehicle V02 as the vehicle 2 to be dispatched.

In the present embodiment, vehicle V01 and vehicle V02 are identified as described above.

For convenience of explanation, a process executed with respect to vehicle V01 will be described first.

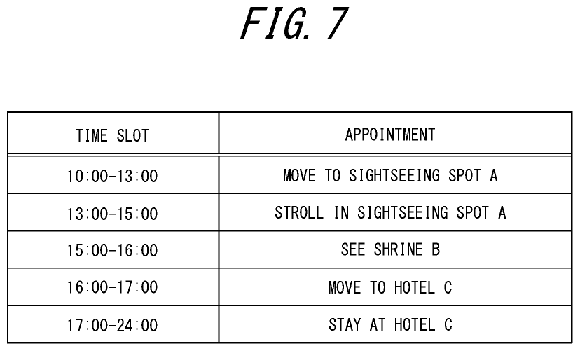

The control apparatus 1 refers to the vehicle DB illustrated in FIG. 6, to search for the provision time of vehicle V01. The control apparatus 1 determines that the provision time of vehicle V01 is “while strolling at a sightseeing spot”. The control apparatus 1 refers to the schedule DB illustrated in FIG. 7. In the schedule DB, information on time slots and appointments is stored in association with each other. The control apparatus 1 acquires, from the schedule DB, information on a schedule of the user on that day, and identifies that the user will visit sightseeing spot A.

The control apparatus 1 identifies a visiting place of the user and an arrival time at the visiting place. Specifically, the control apparatus 1 determines, from the schedule of the user, that the user will visit sightseeing spot A, and that the arrival time at sightseeing spot A is 13:00. In other words, sightseeing spot A will be the location of the user at 13:00. The control apparatus 1 determines to dispatch vehicle V01 to sightseeing spot A at 13:00.

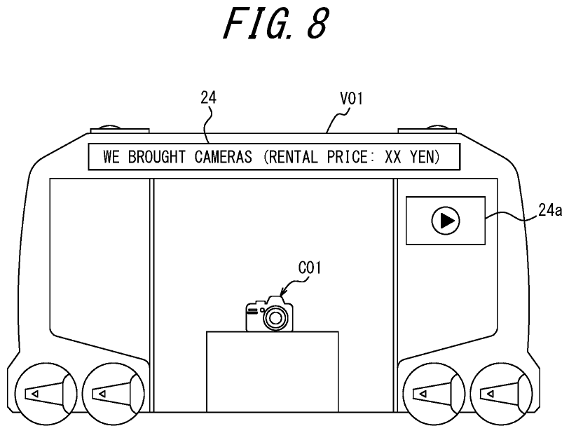

The control apparatus 1 controls vehicle V01 to move to sightseeing spot A at 13:00. The control apparatus 1 performs control to provide a product at sightseeing spot A. Specifically, as illustrated in FIG. 8, when vehicle V01 arrives at sightseeing spot A, vehicle V01 opens a door and presents camera C01.

As an additional example, the display 24a may provide information explaining how to use the product or the service. For example, the display 24a may play a video explaining how to use camera C01. Additionally or alternatively, vehicle V01 may output audio explaining how to use camera C01.

The vehicle 2 displays, on the display 24, that camera C01 has been brought and that rental price for camera C01 is XX yen. The user can use camera C01, by making a payment, in the vehicle 2, at the price displayed. As an additional example, the display 24 may display a use period for camera C01.

As an alternative example, the rental price is adjustable. The number of times that camera C01 has been rented by any user may be stored in the memory 13. Prior to presentation of camera C01 by vehicle V01, the control apparatus 1 may identify the number of times that camera C01 has been leased in the past, and adjust the rental price according to the number of times it has been leased. For example, as the number of times it has been leased increases, the camera C01 is more used. Therefore, the rental price may be adjusted to be lower.

As an alternative example, according to a selection of the user, vehicle V01 may sell, instead of leasing, camera C01. At this time, the display 24 displays a sales price instead of the rental price.

As another alternative example, the control apparatus 1 may perform control to provide the product or the service of a grade in accordance with to the attribute information. For example, the control apparatus 1 may ask the user to input, as the attribute information, the number of years of experience in “photography”, which is the “hobby or preference”. When the control apparatus 1 determines that the number of years of experience exceeds a predetermined number, the control apparatus 1 may present a high-end camera C01. Conversely, when the control apparatus 1 determines that the number of years of experience is less than a predetermined number, the control apparatus 1 may present a camera C01 for beginners.

Hereinafter, a process executed with respect to vehicle V02 will be described.

The control apparatus 1 refers to the vehicle DB illustrated in FIG. 6, and determines that the provision time of vehicle V02 is “while staying in a facility without a nursing room”. The control apparatus 1 refers to the schedule DB illustrated in FIG. 7, and determines whether the user is to stay in a facility without a nursing room. Specifically, upon identifying that, from the schedule DB, the user visits shrine B and hotel C, which are examples of the facilities, the control apparatus 1 searches any suitable database to determine whether a nursing room is provided at shrine B and hotel C. Here, as an example, a case in which the control apparatus 1 determines that a nursing room is not provided at shrine B will be described.

The control apparatus 1 identifies the visiting place of the user and the arrival time at the visiting place. Specifically, the control apparatus 1 determines, from the schedule of the user, that the user will visit shrine B, and that the arrival time at shrine B is 15:00. In other words, shrine B is the location of the user at 15:00. The control apparatus 1 determines to dispatch vehicle V02 to shrine B at 15:00.

The control apparatus 1 may control vehicle V02 to move to the visiting place prior to arrival of the user at the visiting place. Specifically, the control apparatus 1 may control vehicle V02 to move to Shrine B prior to arrival of the user at shrine B at 15:00. In this manner, the control apparatus 1 proactively controls vehicle V02 to move to shrine B.

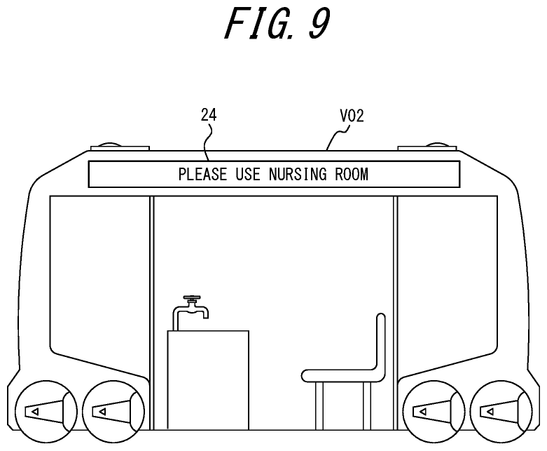

The control apparatus 1 controls the vehicle V02 to perform control to provide a service at the location of the user. Specifically, upon identifying that the user has arrived at shrine B, vehicle V02 opens a door, as illustrated in FIG. 9, to provide the user with a nursing room. The display 24 displays that the nursing room is available.

As an additional example, when providing the user with the product or the service, vehicle V01 and vehicle V02 may receive any baggage (for example, clothing that has been worn) from the user, and, after washing the baggage (for example, washing the clothing that has been worn) at any suitable place, may deliver the baggage to a pre-registered home.

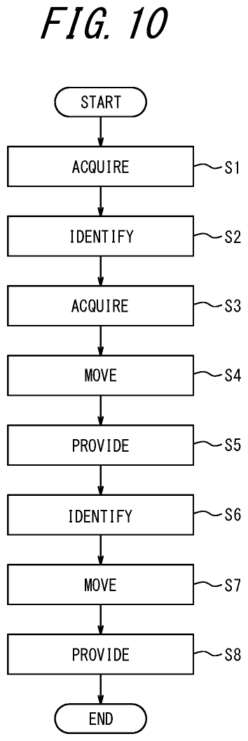

With reference to FIG. 10, a control method executed by the control apparatus 1 will be described. Here, as an example, a process for providing a product will be described first, and a process for providing a service will be described later.

In Step S1, the control apparatus 1 acquires, from the user terminal 3, attribute information of the user.

In Step S2, the control apparatus 1 identifies the vehicle 2 that stores a product according to the attribute information of the user, or the vehicle 2 that stores a service according to the attribute information.

In Step S3, the control apparatus 1 refers to a schedule DB to acquire information on a schedule of the user.

In Step S4, the control apparatus 1 controls the vehicle 2 to move to a location of the user.

In Step S5, the control apparatus 1 controls the vehicle 2 to provide the user with the product at the location of the user.

In Step S6, the control apparatus 1 identifies, from the schedule of the user, a visiting place of the user, and identifies a service that is not provided at the visiting place.

In Step S7, upon identifying, from the schedule, the visiting place of the user and an arrival time at the visiting place, the control apparatus 1 controls the vehicle 2 to move to the visiting place prior to arrival of the user at the visiting place at the arrival time.

In step S8, the control apparatus 1 controls the vehicle 2 to provide the user with the service that is identified in Step S6.

As has been described, according to the present embodiment, the control apparatus 1 identifies a vehicle 2 that stores a product according to attribute information for a user, or a vehicle 2 that can provide a service according to the attribute information. The control apparatus 1 controls the vehicle 2 to move to provide the product or the service at a location of the user. According to this configuration the control apparatus 1 can provide the user with the product or the service according to the attribute of the user. Therefore, the user can travel without bringing their own baggage to a travel destination. Thus, the control apparatus 1 enables the user to travel freely, without taking baggage.

Moreover, according to the present embodiment, the providing of the product or the service includes providing information explaining how to use the product or the service. According to this configuration, the control apparatus 1 can help the user to understand the usage, thereby improving user satisfaction.

Moreover, according to the present embodiment, the control apparatus 1 provides a product or a service of a grade in accordance with the attribute information of the user. According to this configuration, the control apparatus 1 can provide the user with the product or the service according to the experience or familiarity of the user, thereby improving user satisfaction.

Moreover, according to the present embodiment, the providing of the product includes selling or leasing of the product. According to this configuration, the control apparatus 1 enables the user to choose whether to buy or rent the product, thereby improving user satisfaction.

Moreover, according to the present embodiment, when leasing the product, the control apparatus 1 adjusts the rental price according to the number of times that the product has been leased in the past. According to this configuration, the control apparatus 1 can flexibly set the price according to the state of the product.

Moreover, according to the present embodiment, the control apparatus 1 acquires a schedule of the user, and identifies a visiting place of the user and an arrival time of the user at the visiting place. The control apparatus 1 further performs control to provide the product or the service according to the visiting place of the user and the arrival time of the user. According to this configuration, the control apparatus 1 can identify the visiting place of the user and the arrival time of the user, and can thereby reliably provide the user with the product or the service from the vehicle 2.

Moreover, according to the present embodiment, the control apparatus 1 identifies a product or a service that is not provided at the identified visiting place, and performs control to provide the the identified product or the identified service. According to this configuration, the control apparatus 1 can reduce inconvenience felt by the user by not being provided with a particular product or service, thereby improving the travel experience of the user.

Moreover, according to the present embodiment, the control apparatus 1 controls the vehicle 2 to move to the visiting place prior to arrival of the user at the visiting place at the arrival time. According to this configuration, the control apparatus 1 enables the vehicle 2 to proactively move to the user's visiting place. Thus, the user can use the product or the service immediately after arriving at the visiting place.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means or each step can be rearranged without logical inconsistency, and a plurality of means or steps can be combined together or divided.

For example, in the above embodiment, a program that executes all or some of the functions or processing of the control apparatus 1 may be recorded on a computer-readable recording medium. The computer-readable recording medium includes a non-transitory computer-readable medium and may be a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of the server and transmitting the program from the server to another computer. The program may also be provided as a program product. The present disclosure may also be implemented as a program that can be executed by a processor.

1. A control apparatus for controlling a vehicle, the control apparatus comprising a controller, wherein the controller is configured to:
identify a vehicle that stores a product in accordance with attribute information for a user, or a vehicle that can provide a service in accordance with the attribute information; and
perform control to move the vehicle to provide the product or the service at a location of the user.

2. The control apparatus according to claim 1, wherein providing the product or the service comprises providing information explaining how to use the product or the service.

3. The control apparatus according to claim 1, wherein the controller is configured to perform control to provide, as the product or the service, a product or a service of a grade in accordance with the attribute information for the user.

4. The control apparatus according to claim 1, wherein providing the product comprises selling or leasing the product.

5. The control apparatus according to claim 4, wherein, when leasing the product, the controller adjusts a rental price according to the number of times that the product has been leased in the past.

6. The control apparatus according to claim 1, wherein the controller is configured to:
acquire a schedule of the user;
identify a visiting place of the user and an arrival time of the user at the visiting place; and
perform control to provide the product or the service according to the visiting place of the user and the arrival time of the user.

7. The control apparatus according to claim 6, wherein the controller is configured to identify a product or a service which is not provided at the identified visiting place; and perform control to provide the identified product or the identified service.

8. The control apparatus according to claim 6, wherein the controller is configured to move the vehicle to the visiting place prior to arrival of the user at the visiting place at the arrival time.

9. A vehicle equipped with the control apparatus according to claim 1.

10. A non-transitory computer-readable medium storing a program configured to cause a computer, as a control apparatus for controlling a vehicle, to execute:
identifying a vehicle that stores a product in accordance with attribute information for a user, or a vehicle that can provide a service in accordance with the attribute information; and
control to move the vehicle to provide the product or the service at a location of the user.

11. The non-transitory computer-readable medium according to claim 10, wherein providing the product or the service comprises providing information explaining how to use the product or the service.

12. The non-transitory computer-readable medium according to claim 10, wherein the program is configured to cause the computer to further execute control to provide, as the product or the service, a product or a service of a grade in accordance with the attribute information for the user.

13. The non-transitory computer-readable medium according to claim 10, wherein providing the product comprises selling or leasing the product.

14. The non-transitory computer-readable medium according to claim 13, wherein the program is configured to cause the computer to, when leasing the product, further execute an operation to adjust a rental price according to the number of times that the product has been leased in the past.

15. The non-transitory computer-readable medium according to claim 10, wherein the program is configured to cause the computer to further execute:
acquiring a schedule of the user;
identifying a visiting place of the user and an arrival time of the user at the visiting place; and
control to provide the product or the service according to the visiting place of the user and the arrival time of the user.

16. A control method performed by a control apparatus for controlling a vehicle, the control method comprising:
identifying a vehicle that stores a product in accordance with attribute information for a user, or a vehicle that can provide a service in accordance with the attribute information; and
control to move the vehicle to provide the product or the service at a location of the user.

17. The control method according to claim 16, wherein providing the product or the service comprises providing information explaining how to use the product or the service.

18. The control method according to claim 16, wherein the control method further comprises control to provide, as the product or the service, a product or a service of a grade in accordance with the attribute information for the user.

19. The control method according to claim 16, wherein providing the product comprises selling or leasing the product.

20. The control method according to claim 19, further comprising, when leasing the product, adjusting a rental price according to the number of times that the product has been leased in the past.
